(19) United States
(12) Patent Application Publication
(10) Pub. No.: US 2007/0124545 A1
(43) Pub. Date: May 31, 2007

(54) Automatic yielding on lock contention for multi-threaded processors

(76) Inventors: Anton Blanchard, Marrickville (AU); Benjamin Herrenschmidt, Barton (AU); Paul F. Russell, Queanbeyan (AU)

Correspondence Address: LIEBERMAN & BRANDSDORFER, LLC, 802 STILL CREEK LANE, GAITHERSBURG, MD, 20878, US

(21) Appl. No.: 11/288,862

(22) Filed: Nov. 29, 2005

(51) Int. Cl. G06F 12/14

(52) U.S. Cl. 711/152

(57) ABSTRACT

A method and system are provided for managing processor resources in a multi-threaded processor. When attempting to acquire a lock on a shared resource, an initial test is conducted to determine if there is a lock address for the shared resource in a lock table. If it is determined that the address is in the lock table, the lock is in use by another thread. Processor resources associated with the lock requesting thread are mitigated so that processor resources may focus on the lock holding thread prior to the requesting thread spinning on the lock. Processor resources are assigned to the threads based upon the assigned priorities, thereby allowing the processor to allocate more resources to a thread assigned a high priority and fewer resources to a thread assigned a low priority.

### BACKGROUND OF THE INVENTION

1. Technical Field

This invention relates to mitigating lock contention for multi-threaded processors. More specifically, the invention relates to allocating priorities among threads and associated processor resources.

2. Description Of The Prior Art

Multiprocessor systems by definition contain multiple processors, also referred to herein as CPUs, that can execute multiple processes or multiple threads within a single process simultaneously, in a manner known as parallel computing. In general, multiprocessor systems execute multiple processes or threads faster than conventional single processor systems, such as personal computers (PCs), that execute programs sequentially. The actual performance advantage is a function of a number of factors, including the degree to which parts of a multithreaded process and/or multiple distinct processes can be executed in parallel and the architecture of the particular multiprocessor system at hand.

Shared memory multiprocessor systems offer a common physical memory address space that all processors can access. Multiple processes therein, or multiple threads within a process, can communicate through shared variables in memory which allow the processes to read or write to the same memory location in the computer system. Message passing multiprocessor systems, in contrast to shared memory systems, have a distinct memory space for each processor. Accordingly, messages passing through multiprocessor systems require processes to communicate through explicit messages to each other.

In a multi-threaded processor, one or more threads may require exclusive access to some resource at a given time. A memory location is chosen to manage access to that resource. A thread may request a lock on the memory location to obtain exclusive access to a specific resource managed by the memory location. FIG. 1 is a flow chart (10) illustrating a prior art solution for resolving lock contention between two or more threads on a processor for a specific shared resource managed by a specified memory location. When a thread requires a lock on a shared resource, the thread loads a lock value from memory with a special “load with reservation” instruction (12). This “reservation” indicates that the memory location should not be altered by another CPU or thread. The memory location contains a lock value indicating whether the lock is available to the thread. An unlocked value is an indication that the lock is available, and a locked value is an indication that the lock is not available. If the value of the memory location indicates that the lock is unavailable, the shared resource managed at the memory location is temporarily owned by another thread and is not available to the requesting thread. Similarly, if the memory location indicates that the lock is available, the shared resource managed at the memory location is not owned by another thread and is available to the requesting thread. In one embodiment, the locked state may be represented by a bit value of “1” and the unlocked state may be represented by a bit value of “0”. However, the bit values may be reversed. In the illustration shown in FIG. 1, a bit value of “1” indicates the shared resource is in a locked state and a bit value of “0” indicates the shared resource is in an unlocked state. Following step (12), a test (14) is conducted to determine if the memory location is locked. A positive response to the test at step (14) will result in the thread spinning on the lock on the memory location until it attains an unlocked state, i.e. return to step (12), until a response to the test at step (14) is negative. A negative response to the test at step (14) will result in the requesting thread attempting to store a bit into memory with reservation to try to acquire the lock on the shared resource (16). Thereafter, another test (18) is conducted to determine if the attempt at step (16) was successful. If another thread has altered the memory location containing the lock value since the load with reservation in step (12), the store at (16) will be unsuccessful. Since the shared resource is shared by two or more threads, it is possible that more than one thread may be attempting to acquire a lock on the shared resource at the same time. A positive response to the test at step (18) is an indication that another thread has acquired a lock on the shared resource. The thread that was not able to store the bit into memory at step (16) will spin on the lock until the shared resource attains an unlocked state, i.e. return to step (12). A negative response to the test at step (18) will result in the requesting thread acquiring the lock (20). The process of spinning on the lock enables the waiting thread to attempt to acquire the lock as soon as the lock is available. However, the process of spinning on the lock also slows down the processor supporting the active thread as the act of spinning utilizes processor resources as it requires that the processor manage more than one operation at a time. This is particularly damaging when the active thread possesses the lock as it is in the interest of the spinning thread to yield processor resources to the active thread. Accordingly, the process of spinning on the lock reduces resources of the processor that may otherwise be available to manage a thread that is in possession of a lock on the shared resource.

Therefore, there is a need for a solution which efficiently detects whether a lock on a resource shared by two or more threads is possessed by a thread within the same CPU, or by a thread on another CPU, and appropriately yields processor resources.

### SUMMARY OF THE INVENTION

This invention comprises a method and system for managing operation of a multi-threaded processor.

In one aspect of the invention, a method is provided for mitigating overhead on a multi-threaded processor. Presence of a lock address for a shared resource in a lock table is determined. The processor adjusts allocation of resources to a thread holding the lock in response to presence of the lock address in the lock table.

In another aspect of the invention, a computer system is provided with a multi-threaded processor. A lock table is provided to store a lock address for a shared resource held by a thread. A manager communicates with the processor to adjust allocation of processor resources from the lock requesting thread to a thread in possession of the lock if it is determined that a lock address is present in the lock table.

In yet another aspect of the invention, an article is provided with a computer readable medium. Instructions in the medium are provided for a lock requesting thread to request a lock on a shared resource from a multi-threaded processor. Instructions in the medium are also provided for evaluating a lock table to determine if a lock address is present in response to receipt of the instructions requesting the lock. If it is determined that the lock address is present in the lock table, instructions are provided to adjust allocation of processor resources to the lock holding thread.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart illustrating a prior art process of a thread obtaining a lock on a shared resource.

FIG. 2 is a flow chart of a process of a thread obtaining a lock on a shared resource according to the preferred embodiment of this invention, and is suggested for printing on the first page of the issued patent.

FIG. 3 is block diagram demonstrating release of a lock by a thread.

FIG. 4 is a block diagram demonstrating removal of address from a lock table.

FIG. 5 is block diagram of a CPU with a manager to facilitate threaded processing.

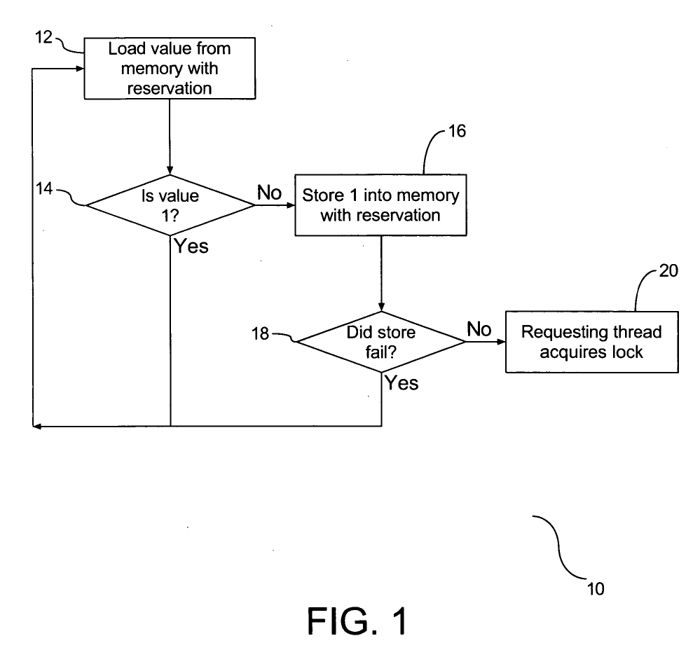

### DESCRIPTION OF THE PREFERRED EMBODIMENT

### Overview

In a multi-threaded processor, a lock on a memory location managing a shared resource may be obtained by a first requesting thread. The operation of obtaining the lock involves writing a value into a memory location. At an initial step of requesting a lock on the shared resource, a determination is made of the presence of a lock held by a thread on this same CPU for the shared resource. Recordation of lock activity is maintained in a lock table. Processor resources are proportionally allocated to the lock holding thread and the lock requesting thread in response to presence of the lock in the lock table. Allocation of resources enables the processor to focus resources on a lock holding thread while enabling a lock requesting thread to spin on the lock with fewer processor resources allocated thereto.

### Technical Details

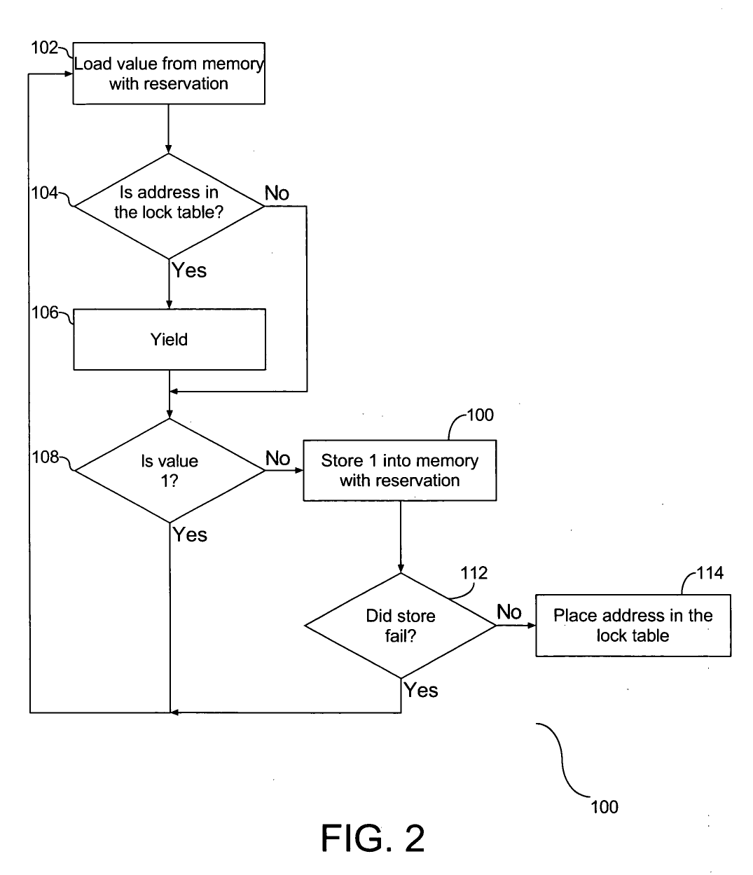

Multi-threaded processors support software applications that execute threads in parallel instead of processing threads in a linear fashion thereby allowing multiple threads to run simultaneously. FIG. 2 is a flow chart (100) illustrating a method for allocating processor resources. In a multi-threaded processor, two or more threads may be serviced by the processor at any one time. However, the processor may only service a single lock on a shared resource by one of the threads. A thread requesting a lock on the shared resource loads a value from the memory with reservation (102). This “reservation” indicates that the memory location should not be altered by another CPU or thread. The memory location contains an entry indicating whether the lock is available to the thread. An unlocked value is an indication that the lock is available, and a locked value is an indication that the lock is not available. If the value of the memory location indicates that the lock is unavailable, the shared resource managed at the memory location is temporarily owned by another thread and is not available to the requesting thread. Similarly, if the memory location indicates that the lock is available, the shared resource managed at the memory location is not owned by another thread and is available to the requesting thread. In one embodiment, the locked state may be represented by a bit value of “1” and the unlocked state may be represented by a bit value of “0”. However, the bit values may be reversed. In the illustration shown in FIG. 2, a bit value of “1” indicates the shared resource is in a locked state and a bit value of “0” indicates the shared resource is in an unlocked state. The value loaded from address memory will provide the address of the memory location managing access to a specified shared resource. Following the step of loading a value from address memory at step (102), a test is conducted to determine if the address loaded at step (102) is in a lock table (104). The lock table is a table maintained in memory to organize allocation of a lock on the shared resource to one or more processor threads. In one embodiment, the lock table is maintained in volatile memory. A positive response to the test at step (104) is an indication that one of the other threads on the processor holds a lock on the shared resource. An instruction is issued to the processor to mitigate allocation of resources to the lock requesting thread (106). In one embodiment, the instruction is for the processor to allocate more resources to the lock holding thread, and allocate fewer resources to the lock requesting thread. Accordingly, the first step in determining availability of a lock on the shared resource is for the requesting thread to determine if another thread holds the lock on the shared resource, and to allocate processor resources in the event a non-lock holding thread holds the lock.

Following mitigation of allocation of processor resources to the lock requesting thread at step (106) or a negative response to the test at step (104), a test (108) is conducted to determine if the state of the shared resource is locked, i.e. held by another thread, or unlocked. If the state of the shared resource is locked, the shared resource is not available to the requesting thread. Similarly, if there is no lock on the shared resource, i.e. the state of the shared resource is unlocked, the shared resource is available to the requesting thread. In one embodiment, the locked state may be represented by a bit value of “1” and the unlocked state may be represented by a bit value of “0”. However, in another embodiment, the bit values may be reversed. In the illustration shown in FIG. 2, a bit value of “1” indicates the shared resource is in a locked state and a bit value of “0” indicates the shared resource is in an unlocked state. A positive response to the test at step (108) will result in the requesting thread spinning on the lock as demonstrated in FIG. 2 by a return to step (102). Similarly, a negative response to the test at step (108) will result in the requesting thread storing a “1” bit into memory with reservation (110). This “reservation” indicates that the memory location should not be altered by another CPU or thread. In one embodiment, the memory is random access memory (RAM). In one embodiment, the store at step (110) is a store conditional instruction and does not guarantee that the requesting thread that implements the store will obtain the lock. Since there are multiple threads on the processor, it is possible that another thread may acquire the lock on the shared resource prior to or during the conditional store instruction. Following step (110), a test (112) is conducted to determine if the conditional store instruction at step (110) failed. A positive response to the test at step (112) will cause the requesting thread to spin on the lock as demonstrated in FIG. 2 by a return to step (102). However, a negative response to the test at step (112) will result in the requesting thread acquiring the lock by placing the memory address for the lock in the lock table (114). As shown, assignment and/or adjustment of processor resources takes place following the initial lock request to enable the requesting thread to spin on the lock without significantly affecting processor resources.

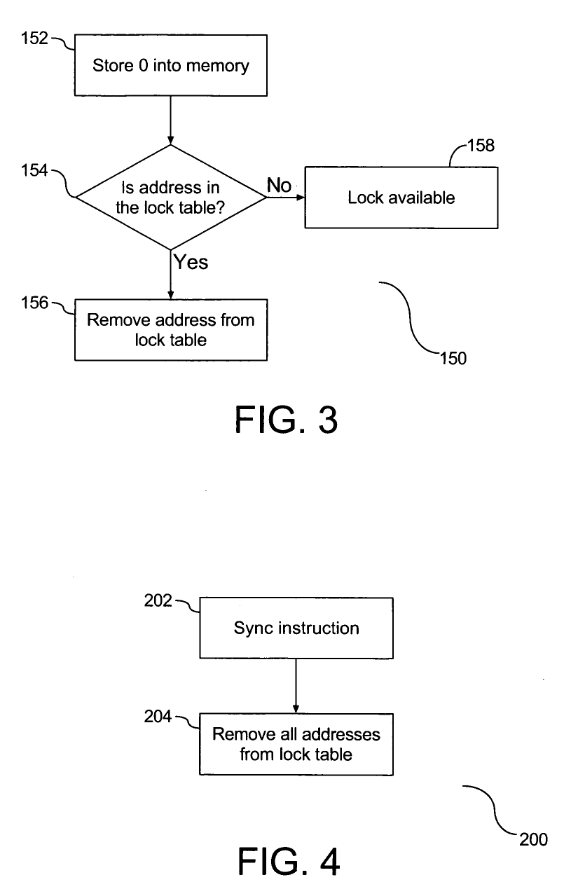

As noted above, a requesting thread may obtain a lock on the shared resource or spin on the lock depending upon whether another thread holds a lock on the shared resource. In general, the thread holding the lock releases the lock upon completion of one or more tasks that required the shared resource. FIG. 3 is a flow chart (150) demonstrating how a thread holding a lock on the shared resource releases the lock. As noted above, in one embodiment a bit value of “1” indicates the shared resource is in a locked state and a bit value of “0” indicates the shared resource is in an unlocked state. In the illustration shown in FIG. 3, a bit value of “1” indicates the shared resource is in a locked state and a bit value of “0” indicates the shared resource is in an unlocked state. To release the lock, the lock holding thread stores a “0” bit into memory (152). Thereafter, a test is conducted to determine if there is an address for a memory location managing the shared resource in the lock table (154). A positive response to the test at step (154) is an indication that the lock holding thread has not released the lock. In order to release the lock, the lock holding thread removes the address of the memory location managing the resource from the lock table (156). Similarly, a negative response to the test at step (154) indicates that the thread does not own the lock on the shared resource, and the lock is now available for a requesting thread (158). Accordingly, the process of releasing a lock requires storing a value in memory and potentially removing the lock address from the lock table.

As shown in FIG. 3, a thread may release a hold on the lock by changing the bit in the appropriate memory location from a “1” to a “0”, and/or ensuring that the address of the memory location managing the shared resource is removed from the lock table. However, the process of releasing the lock does not remove the lock acquisition(s) transaction from memory. In one embodiment, memory is random access memory (RAM). FIG. 4 is a flow chart (200) demonstrating an example of how lock transactions may be removed from memory. The operating system issues a sync instruction (202). The sync instruction forces the operating system to operate at a slower pace so that shared resource instructions may be synchronized. In one embodiment, a sync instruction is automatically issued when the operating system switches running of programs. Following execution of the sync instruction at step (202), all addresses of one or more memory locations managing shared resources are removed from the lock table (204). In one embodiment, it may become advisable to issue a sync instruction if the lock table cannot accept further entries due to size constraint. At such time as the lock table is full and cannot accept further entries, the processor continues to operate with one or more threads spinning on the lock. Accordingly, the sync instruction enables the lock table to accommodate future transactions associated with a lock request for a shared resource.

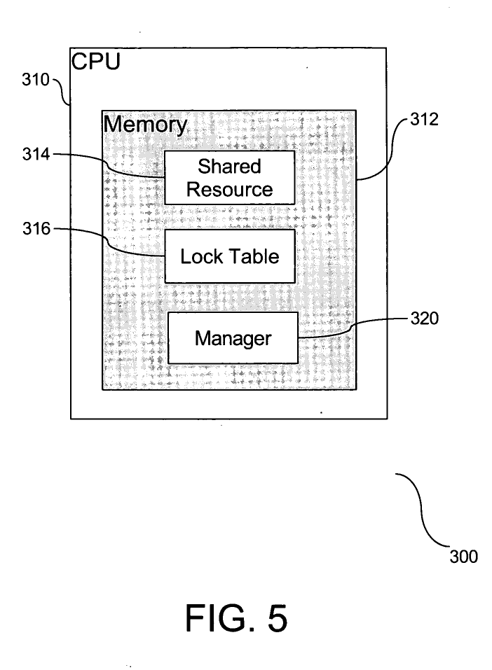

In one embodiment, the multi-threaded computer system may be configured with a shared resource management tool in the form of a manager to facilitate with assignment of processor resources to lock holding and non-lock holding threads. FIG. 5 is a block diagram (300) of a processor (310) with memory (312) having a shared resource (314) and a lock table (316). A manager (320) is provided to facilitate communication of lock possession between a thread and the processor. The manager (320) may be a hardware element or a software element. The manager (320) shown in FIG. 5 is embodied within memory (312). In this embodiment, the manager may be a software component stored on a computer-readable medium as it contains data in a machine readable format. For the purposes of this description, a computer-useable, computer-readable, and machine readable medium or format can be any apparatus that can contain, store, communicate, propagate, or transport the program for use by or in connection with the instruction execution system, apparatus, or device. If it is determined by the requesting thread that another thread holds a lock on the shared resource, the manager communicates with the processor to raise a priority to the lock holding thread and lower a priority to the non-lock holding thread. In addition, the manager communicates with the non-lock holding thread authorization to spin on the lock. Accordingly, the shared resource management tool may be in the form of hardware elements in the computer system or software elements in a computer-readable format or a combination of software and hardware elements.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

### Advantages Over the Prior Art

Priorities are allocated to both lock holding and non-lock holding threads. The allocation of priorities is conducted following an initial load from memory. This enables the processor to allocate resources and assign priorities based upon the presence or absence of a lock on the shared resource prior to the lock requesting thread issuing a conditional store instruction. If a thread holds a lock on the shared resource, a thread requesting the lock may spin on the lock. The processor allocates resources based upon availability of the lock. For example, the processor allocates more resources to a lock holding thread, and mitigates allocation of resources to a thread spinning on the lock. The allocation of resources enables efficient processing of the lock holding thread while continuing to allow the non-lock holding thread to spin on the lock.

### Alternative Embodiments

It will be appreciated that, although specific embodiments of the invention have 10 been described herein for purposes of illustration, various modifications may be made without departing from the spirit and scope of the invention. In particular, processor resources may be proportionally allocated among active threads. For example, yielding of processor resources may include allocation of processor resources to enable the processor to devote resources to a lock holding thread up to a ratio of 32:1. In one embodiment, a sliding scale formula may be implemented to appropriate processor resources. The sliding scale formula may be implemented by the processor independently or with assistance of the manager (320). As shown in FIG. 5, the manager (320) may be a hardware element residing within the CPU. In an alternative embodiment, the manager may reside within memory (312), or it may be relocated to reside within chip logic. Accordingly, the scope of protection of this invention is limited only by the following claims and their equivalents.

We claim:

1. A method for mitigating overhead on a multi-threaded processor, comprising:
determining presence of a lock address in a lock table for a shared resource;
adjusting allocation of processor resources to a thread holding said lock responsive to presence of said lock address in said lock table.

2. The method of claim 1, further comprising placing said lock address in said lock table responsive to absence of said lock address in said lock table.

3. The method of claim 1, further comprising removing said address from said lock table to release said lock.

4. The method of claim 1, further comprising issuing a sync instruction to remove said lock address from memory.

5. The method of claim 1, wherein said lock table is stored in volatile memory.

6. The method of claim 1, wherein the step of adjusting allocation of processor resources to a thread holding said lock includes increasing a priority level of said thread holding said lock, and lowering a priority level of a non-lock holding thread.

7. A computer system comprising:
a multi-threaded processor;
a lock table adapted to store a lock address for a shared resource held by a thread; and
a manager adapted to communicate with said processor to adjust allocation of processor resources from a lock requesting thread to a thread in possession of said lock in response to presence of said lock address in said lock table.

8. The system of claim 7, further comprising said lock address adapted to be placed in said lock table in response to absence of a lock address in said lock table from another thread.

9. The system of claim 7, further comprising a release instruction adapted to remove said lock address from said lock table.

10. The system of claim 7, further comprising a sync instruction adapted to remove all lock addresses from memory.

11. The system of claim 7, wherein said lock table is stored in volatile memory.

12. The system of claim 7, wherein adjustment of processor resources is adapted to allocate more resources to said thread in possession of said lock.

13. The system of claim 7, wherein adjustment of processor resources is adapted to allocate fewer resources to a thread spinning on said lock.

14. An article comprising:
a computer readable medium;
instructions in said medium for a thread to request a lock on a shared resource from a multi-threaded processor;
instructions in said medium for evaluating a lock table to determine presence of a lock address responsive to said instruction requesting said lock; and
instructions in said medium for a processor managing said resource to adjust allocation of processor resources to a lock holding thread responsive to presence of said lock address in said lock table.

15. The article of claim 14, further comprising instructions in said medium for placing a lock address in said lock table responsive to absence of said lock address in said lock table.

16. The article of claim 14, further comprising a release instruction in said medium for removing said lock address from said lock table.

17. The article of claim 14, further comprising a sync instruction in said medium for removing all lock addresses from memory.

18. The article of claim 14, wherein said lock table is stored in volatile memory.

19. The article of claim 14, wherein said instruction to adjust allocation of processor resources to a lock holding thread includes increasing processor resources for said lock holding thread.

20. The article of claim 14, wherein said instruction to adjust allocation of processor resources to lock holding thread includes decreasing processor resources for a non-lock holding thread.
